(19) United States
(12) Patent Application Publication
(10) Pub. No.: US 2013/0076326 A1
(43) Pub. Date: Mar. 28, 2013

(54) DUAL-MODE SWITCHING REGULATOR

(71) Applicant: Soo Woong LEE, Seoul (KR)

(72) Inventor: Soo Woong LEE, Seoul (KR)

(73) Assignee: SAMSUNG ELECTRO-MECHANICS CO., LTD.

(21) Appl. No.: 13/333,415

(22) Filed: Dec. 21, 2011

(30) Foreign Application Priority Data
Sep. 27, 2011 (KR) 10-2011-0097582

(51) Int. Cl. G05F 1/10

(52) U.S. Cl. 323/284

(57) ABSTRACT

There is provided a dual-mode switching regulator including: a comparison unit comparing an input voltage input through an input terminal with a pre-set reference voltage and outputting a comparison result signal; a switching signal generation unit generating a regulator selection signal for controlling a previously connected regulator path and a bypass selection signal for controlling a previously connected bypass path according to the comparison result signal; a regulator included in the regulator path and converting the input voltage to a pre-set voltage; a regulator path selection unit switching the regulator path including the regulator between the input terminal and an output terminal on or off, according to the regulator selection signal; and a bypass path selection unit switching the bypass path connecting the input terminal and the output terminal without passing through the regulator on or off, according to the bypass selection signal.

### CROSS-REFERENCE TO RELATED APPLICATIONS

This application claims the priority of Korean Patent Application No. 10-2011-0097582 filed on Sep. 27, 2011, in the Korean Intellectual Property Office, the disclosure of which is incorporated herein by reference.

### BACKGROUND OF THE INVENTION

1. Field of the Invention

The present invention relates to a dual-mode switching regulator operating in one of a bypass mode for low voltage operation, and a regulation mode for normal operation, according to the level of an input voltage, thus enhancing efficiency.

2. Description of the Related Art

In general, in majority of commercial integrated circuits (IC), an input voltage can be variably used according to users' needs. In order for the actual IC internal circuit to exhibit optimized performance, a regulator should convert input power having a varying voltage level to a power having a particular voltage level and supply the same to the internal circuit.

In general, a regulator serves to convert an external voltage, varying within a particular range, to a particular power voltage required in an internal circuit. In particular, in order to convert an external voltage to a particular internal voltage, a switching regulator using a switching device may be used.

A low dropout (LDO) regulator may be used as an existing switching regulator in order to minimize a voltage drop in the regulator when an external voltage is low.

The LDO regulator is used when a value as close as possible to an input voltage is desired to be obtained as an output voltage value, and here, the input voltage is converted to a pre-set constant voltage.

The existing switching regulator does not have a problem in providing a desired output voltage when an input voltage is higher than an output voltage; however, when an input voltage is lower than an output voltage, a voltage drop is further generated by the switching device.

Namely, compared with a general regulator, an LDO regulator can reduce a voltage drop of 0.5V or higher, but to a degree, it also has the problem of voltage drop. Here, the magnitude of the voltage drop is the product of a load current of the regulator and output resistance of a pass transistor.

For example, in a case in which the LDO regulator has a voltage drop of about 0.2V, when an input voltage of 5V is converted, an internal voltage of about 4.8V can be generated. However, due to a lack of a margin with respect to a DC voltage, when an input voltage is equal to an output voltage or when a difference between an input voltage and an output voltage is lower than a voltage drop of a switching device (e.g., a transistor), characteristics desired by the user cannot be obtained from the LDO regulator.

### SUMMARY OF THE INVENTION

An aspect of the present invention provides a dual-mode switching regulator operating in one of a bypass mode for low voltage operation and a regulation mode for normal operation, according to the level of an input voltage, thus enhancing efficiency.

According to an aspect of the present invention, there is provided a dual-mode switching regulator including: a comparison unit comparing an input voltage input through an input terminal with a pre-set reference voltage and outputting a comparison result signal; a switching signal generation unit generating a regulator selection signal for controlling a previously connected regulator path and a bypass selection signal for controlling a previously connected bypass path, according to the comparison result signal; a regulator included in the regulator path and converting the input voltage to a pre-set voltage; a regulator path selection unit switching the regulator path including the regulator between the input terminal and an output terminal on or off, according to the regulator selection signal; and a bypass path selection unit switching the bypass path connecting the input terminal and the output terminal without passing through the regulator on or off, according to the bypass selection signal.

The comparison unit may include an operational amplifier having a non-inverting input terminal receiving the input voltage, an inverting input terminal receiving the reference voltage, and an output terminal outputting the comparison result signal obtained by comparing the input voltage with the reference voltage.

When the input voltage is lower than the reference voltage, the operational amplifier may output a comparison result signal having a low level, and when the input voltage is equal to or higher than the reference voltage, the operational amplifier may output a comparison result signal having a high level.

The switching signal generation unit may generate a regulator selection signal and a bypass selection signal, each including a first switching signal corresponding to a level of the comparison result signal and a second switching signal obtained by inverting the first switching signal.

The switching signal generation unit may include an inverter inverting the comparison result signal, the first switching signal may have a level corresponding to the level of the comparison result signal and the second switching signal may be obtained by inverting the comparison result signal via the inverter.

The regulator path selection unit may include a first switching device connected between the input terminal and the regulator and switched off when the input voltage is lower than the reference voltage and switched on when the input voltage is higher than the reference voltage, according to the regulator selection signal, and a second switching device connected between the regulator and the output terminal and switched off when the input voltage is lower than the reference voltage and switched on when the input voltage is higher than the reference voltage, according to the regulator selection signal.

The first switching device may be configured as a first transmission gate, and the first transmission gate may include a first NMOS transistor having a drain connected to the input terminal, a source connected to the regulator, and a gate receiving the first switching signal, and a first PMOS transistor having a drain connected to the input terminal, a source connected to the regulator, and a gate receiving the second switching signal.

The second switching device may be configured as a second transmission gate, and the second transmission gate may include a second NMOS transistor having a drain connected to the regulator, a source connected to the output terminal, and a gate receiving the first switching signal, and a second PMOS transistor having a drain connected to the regulator, a source connected to the output terminal, and a gate receiving the second switching signal.

The bypass path selection unit may include a third switching device formed on the bypass path between the input terminal and the output terminal and switched on when the input voltage is lower than the reference voltage and switched off when the input voltage is higher than the reference voltage, according to the bypass selection signal.

The third switching device may be configured as a third transmission gate, and the third transmission gate may include a third NMOS transistor having a drain connected to the input terminal, a source connected to the output terminal, and a gate receiving the second switching signal, and a third PMOS transistor having a drain connected to the input terminal, a source connected to the output terminal, and a gate receiving the first switching signal.

According to another aspect of the present invention, there is provided a dual-mode switching regulator including: a comparison unit comparing an input voltage input through an input terminal with a pre-set reference voltage and outputting a comparison result signal; a switching signal generation unit generating a regulator selection signal for controlling a previously connected regulator path and a bypass selection signal for controlling a previously connected bypass path according to the comparison result signal; a regulator included in the regulator path and converting the input voltage to a pre-set voltage; a regulator path selection unit switching the regulator path including the regulator between the input terminal and an output terminal on or off, according to the regulator selection signal; and a bypass path selection unit switching the bypass path connecting the input terminal and the output terminal without passing through the regulator on or off, according to the bypass selection signal, wherein the regulator path selection unit includes a first switching device connected between the input terminal and the regulator and switched off when the input voltage is lower than the reference voltage and switched on when the input voltage is higher than the reference voltage, according to the regulator selection signal, and a second switching device connected between the regulator and the output terminal and switched off when the input voltage is lower than the reference voltage and switched on when the input voltage is higher than the reference voltage, according to the regulator selection signal, and the bypass path selection unit includes a third switching device formed on the bypass path between the input terminal and the output terminal and switched on when the input voltage is lower than the reference voltage and switched off when the input voltage is higher than the reference voltage, according to the bypass selection signal.

The comparison unit may include an operational amplifier having a non-inverting input terminal receiving the input voltage, an inverting input terminal receiving the reference voltage, and an output terminal outputting the comparison result signal obtained by comparing the input voltage with the reference voltage.

When the input voltage is lower than the reference voltage, the operational amplifier may output a comparison result signal having a low level, and when the input voltage is higher than the reference voltage, the operational amplifier may output a comparison result signal having a high level.

The switching signal generation unit may generate a regulator selection signal and a bypass selection signal, each including a first switching signal corresponding to a level of the comparison result signal and a second switching signal obtained by inverting the first switching signal.

The switching signal generation unit may include an inverter inverting the comparison result signal, and the first switching signal may have a level corresponding to the level of the comparison result signal and the second switching signal may be obtained by inverting the comparison result signal via the inverter.

The first switching device may be configured as a first transmission gate, and the first transmission gate may include a first NMOS transistor having a drain connected to the input terminal, a source connected to the regulator, and a gate receiving the first switching signal, and a first PMOS transistor having a drain connected to the input terminal, a source connected to the regulator, and a gate receiving the second switching signal.

The second switching device may be configured as a second transmission gate, and the second transmission gate may include a second NMOS transistor having a drain connected to the regulator, a source connected to the output terminal, and a gate receiving the first switching signal, and a second PMOS transistor having a drain connected to the regulator, a source connected to the output terminal, and a gate receiving the second switching signal.

The bypass path selection unit may include a third switching device formed on the bypass path between the input terminal and the output terminal and switched on when the input voltage is lower than the reference voltage and switched off when the input voltage is higher than the reference voltage, according to the bypass selection signal.

The third switching device may be configured as a third transmission gate, and the third transmission gate may include a third NMOS transistor having a drain connected to the input terminal, a source connected to the output terminal, and a gate receiving the second switching signal, and a third PMOS transistor having a drain connected to the input terminal, a source connected to the output terminal, and a gate receiving the first switching signal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic block diagram of a dual-mode switching regulator according to an embodiment of the present invention;

FIG. 2 is a view showing an example of a switching signal generation unit implemented according to an embodiment of the present invention;

FIG. 3 is a view showing an example of a regulator path selection unit and a bypass path selection unit implemented according to an embodiment of the present invention;

FIG. 4 is a view showing a signal transmission path when a bypass path is selected according to an embodiment of the present invention;

FIG. 5 is a view showing a signal transmission path when a regulator path is selected according to an embodiment of the present invention; and

FIG. 6 is a graph showing voltages of a dual-mode switching regulator according to an embodiment of the present invention.

### DETAILED DESCRIPTION OF THE INVENTION

Exemplary embodiments of the present invention will now be described in detail with reference to the accompanying drawings.

The present invention should not be construed as being limited to the embodiments set forth herein and the embodiments may be used to assist in understanding the technical idea of the present invention. Like reference numerals designate like components having substantially the same constitution and function in the drawings of the present invention.

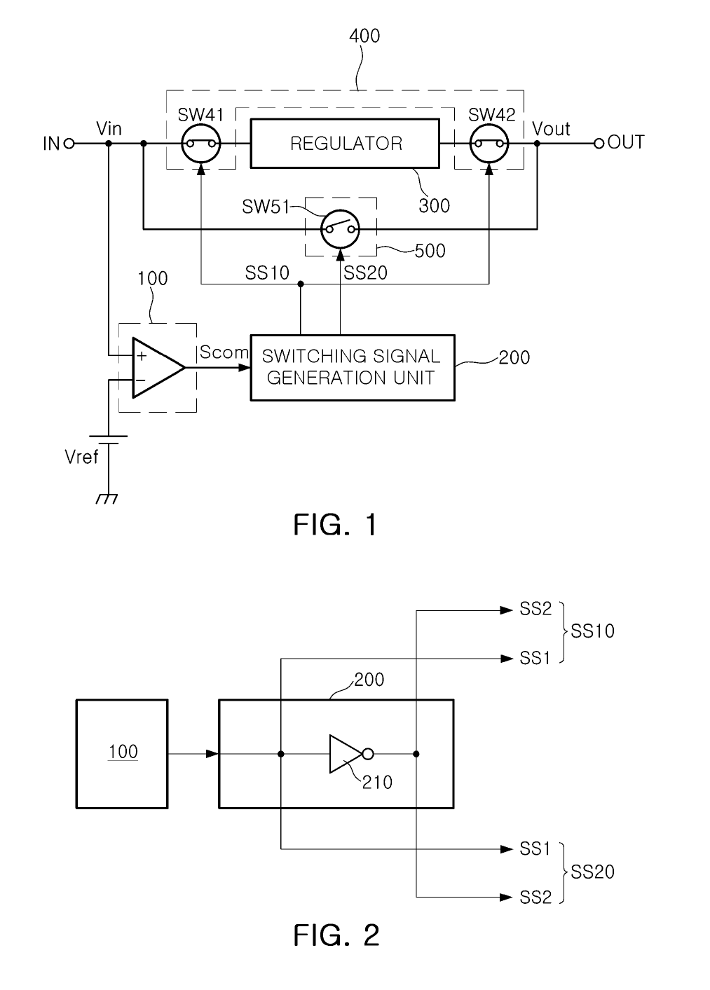

FIG. 1 is a schematic block diagram of a dual-mode switching regulator according to an embodiment of the present invention.

With reference to FIG. 1, a dual-mode switching regulator according to an embodiment of the present invention may include a comparison unit 100 comparing an input voltage Vin input through an input terminal IN with a pre-set reference voltage Vref and outputting a comparison result signal Scom, a switching signal generation unit 200 generating a regulator selection signal SS10 for controlling a previously connected regulator path PH2 and a bypass selection signal SS20 for controlling a previously connected bypass path PH1 according to the comparison result signal Scom, a regulator 300 included in the regulator path PH2 and converting the input voltage Vin to a pre-set voltage, a regulator path selection unit 400 switching the regulator path PH2 including the regulator 300 between the input terminal IN and an output terminal OUT on or off, according to the regulator selection signal SS10, and a bypass path selection unit 500 switching the bypass path PH1 connecting the input terminal IN and the output terminal OUT without passing through the regulator 300 on or off, according to the bypass selection signal SS20.

With reference to FIG. 1, the comparison unit 100 may compare the input voltage Vin input through the input terminal IN with the pre-set reference voltage Vref, and output the comparison result signal Scom having a high level or a low level according to the comparison results obtained by comparing the input voltage Vin and the reference voltage Vref.

For example, the comparison unit 100 may include an operational amplifier having a non-inverting input terminal receiving the input voltage Vin, an inverting input terminal receiving the reference voltage Vref, and an output terminal outputting the comparison result signal Scom obtained by comparing the input voltage Vin with the reference voltage Vref.

Here, when the input voltage Vin is lower than the reference voltage Vref, the operational amplifier may output the comparison result signal Scom having a low level, and when the input voltage Vin is equal to or higher than the reference voltage Vref, the operational amplifier may output the comparison result signal Scom having a high level.

The switching signal generation unit 200 may generate the regulator selection signal SS10 for controlling the previously connected regulator path PH2 and the bypass selection signal SS20 for controlling the previously connected bypass path PH1 according to the comparison result signal Scom from the comparison unit 100.

Here, the regulator path PH2 includes the regulator 300 between the input terminal IN and the output terminal OUT. When the input voltage Vin is equal to or higher than the reference voltage Vref, the input voltage Vin is regulated in the regulator path PH2.

The bypass path PH1 allows the input voltage Vin to be directly transferred from the input terminal IN to the output terminal OUT, without passing through the regulator 300 provided between the input terminal IN and the output terminal OUT, when the input voltage Vin is lower than the reference voltage Vref.

As mentioned above, the regulator 300 is included in the regulator path PH2, and may convert the input voltage Vin to a pre-set voltage.

For example, when the pre-set voltage is +5V, the regulator 300 may constantly output the voltage +5V although the input voltage Vin is higher than +5V.

The regulator path selection unit 400 may switch the regulator path PH2 including the regulator 300 between the input terminal IN and the output terminal OUT on or off, according to the regulator selection signal SS10.

For example, when the input voltage Vin is lower than the reference voltage Vref, the regulator path selection unit 400 may switch off the regulator path PH2. On the contrary, when the input voltage Vin is equal to or higher than the reference voltage Vref, the regulator path selection unit 400 may switch on the regulator path PH2. In this case, in order to reduce power consumption, operation power supplied to the regulator 300 may be cut off.

The bypass path selection unit 500 may switch the bypass path PH1 connecting the input terminal IN and the output terminal OUT without passing through the regulator 300 on or off, according to the bypass selection signal SS20.

For example, when the input voltage Vin is lower than the reference voltage Vref, the bypass path selection unit 500 switches on the bypass path PH1. On the contrary, when the input voltage Vin is equal to or higher than the reference voltage Vref, the bypass path selection unit 500 switches off the bypass path PH1.

FIG. 2 is a view showing an example of the switching signal generation unit implemented according to an embodiment of the present invention.

With reference to FIG. 2, the switching signal generation unit 200 may include an inverter 210 inverting the level of the comparison result signal Scom.

Here, the switching signal generation unit 200 may generate the regulator selection signal SS10 and the bypass selection signal SS20, each including a first switching signal SS1 corresponding to the level of the comparison result signal Scom and a second switching signal SS2 obtained by inverting the first switching signal SS1.

Namely, the first switching signal SS1 may have the level of the comparison result signal Scom, and the second switching signal SS2 may be obtained by inverting the comparison result signal Scom via the inverter 210.

Also, with reference to FIG. 1, the regulator path selection unit 400 may include a first switching device SW41 connected between the input terminal IN and the regulator 300 and switched off when the input voltage Vin is lower than the reference voltage Vref and switched on when the input voltage Vin is equal to or higher than the reference voltage Vref according to the regulator selection signal SS10, and a second switching device SW42 connected between the regulator 300 and the output terminal OUT and switched off when the input voltage Vin is lower than the reference voltage Vref and switched on when the input voltage Vin is equal to or higher than the reference voltage Vref according to the regulator selection signal SS10.

The bypass path selection unit 500 may include a third switching device SW51 formed on the bypass path PH1 between the input terminal IN and the output terminal OUT and switched on when the input voltage Vin is lower than the reference voltage Vref and switched off when the input voltage Vin is equal to or higher than the reference voltage Vref according to the bypass selection signal SS20.

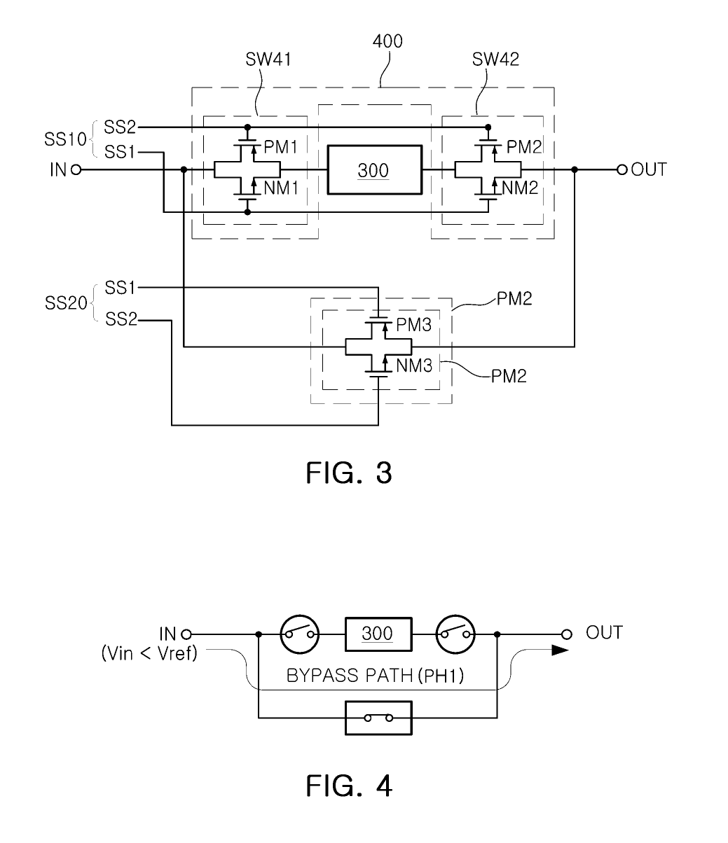

Here, the first switching device SW41, the second switching device SW42, and the third switching device SW51 may be implemented as switchable devices, such as a switching transistor, a switching diode, or the like. In particular, the switching devices may be implemented as transmission gates having a small voltage drop, which will be described with reference to FIG. 3.

FIG. 3 is a view showing an example of the regulator path selection unit and the bypass path selection unit implemented according to an embodiment of the present invention.

The first switching device SW41 may be configured as a first transmission gate. In this case, the first transmission gate may include a first NMOS transistor NM1 having a drain connected to the input terminal IN, a source connected to the regulator 300, and a gate receiving the first switching signal SS1, and a first PMOS transistor PM1 having a drain connected to the input terminal IN, a source connected to the regulator 300, and a gate receiving the second switching signal SS2.

The second switching device SW42 may be configured as a second transmission gate. In this case, the second transmission gate may include a second NMOS transistor NM2 having a drain connected to the regulator 300, a source connected to the output terminal OUT, and a gate receiving the first switching signal SS1, and a second PMOS transistor PM2 having a drain connected to the regulator 300, a source connected to the output terminal OUT, and a gate receiving the second switching signal SS2.

The third switching device SW51 may be configured as a third transmission gate. In this case, the third transmission gate may include a third NMOS transistor NM3 having a drain connected to the input terminal IN, a source connected to the output terminal OUT, and a gate receiving the second switching signal SS2, and a third PMOS transistor PM3 having a drain connected to the input terminal IN, a source connected to the output terminal OUT, and a gate receiving the first switching signal SS1.

When the first, second, and third switching devices are implemented as the transmission gates, the first and second transmission gates are synchronized to be simultaneously switched on or off, and the third transmission gate is switched on or off in opposition to the first and second transmission gates.

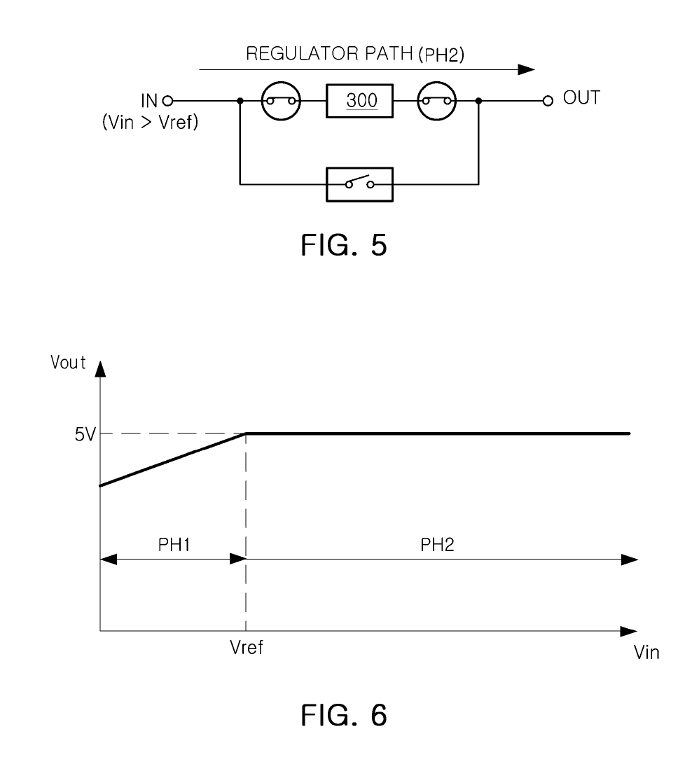

FIG. 4 is a view showing a signal transmission path when the bypass path is selected according to an embodiment of the present invention. FIG. 5 is a view showing a signal transmission path when the regulator path is selected according to an embodiment of the present invention. FIG. 6 is a graph showing voltages of a dual-mode switching regulator according to an embodiment of the present invention.

First, with reference to FIG. 4, when the input voltage Vin is lower than the reference voltage Vref, the first and second switching signals SS1 and SS2 have a low level and a high level, respectively, so that the first NMOS transistor NM1 and the first PMOS transistor PM1 of the first transmission gate and the second NMOS transistor NM2 and the second PMOS transistor PM2 of the second transmission gate are turned off, and the third NMOS transistor NM3 and the third PMOS transistor PM3 of the third transmission gate are turned on.

Accordingly, the bypass path PH1 is connected and the input voltage Vin input through the input terminal IN is directly transferred to the output terminal OUT. As shown in FIG. 6, the input voltage Vin is directly transferred to be an output voltage through the bypass path PH1.

With reference to FIG. 5, when the input voltage Vin is equal to or higher than the reference voltage Vref, the first and second switching signals SS1 and SS2 have a high level and a low level, respectively, so that the first NMOS transistor NM1 and the first PMOS transistor PM1 of the first transmission gate and the second NMOS transistor NM2 and the second PMOS transistor PM2 of the second transmission gate are turned on, and the third NMOS transistor NM3 and the third PMOS transistor PM3 of the third transmission gate are turned off.

Accordingly, the regulator path PH2 is connected and the input voltage Vin input through the input terminal IN is regulated by the regulator 300 on the regulator path PH2 and a voltage regulated by the regulator 300 is output to the output terminal OUT.

As shown in FIG. 6, the input voltage Vin is regulated as a constant voltage (e.g., 5V) through the regulator path PH2 and transferred to be an output voltage.

As set forth above, according to embodiments of the invention, a dual-mode switching regulator can be operated in one of a bypass mode for low voltage operation and a regulation mode for normal operation according to the level of an input voltage. In particular, in case of a low voltage, the dual-mode switching regulator operates in the bypass mode, thereby reducing power consumption, preventing a voltage drop in the bypass mode, and enhancing efficiency.

While the present invention has been shown and described in connection with the embodiments, it will be apparent to those skilled in the art that modifications and variations can be made without departing from the spirit and scope of the invention as defined by the appended claims.

What is claimed is:

1. A dual-mode switching regulator comprising:
a comparison unit comparing an input voltage input through an input terminal with a pre-set reference voltage and outputting a comparison result signal;
a switching signal generation unit generating a regulator selection signal for controlling a previously connected regulator path and a bypass selection signal for controlling a previously connected bypass path, according to the comparison result signal;
a regulator included in the regulator path and converting the input voltage to a pre-set voltage;
a regulator path selection unit switching the regulator path including the regulator between the input terminal and an output terminal on or off, according to the regulator selection signal; and
a bypass path selection unit switching the bypass path connecting the input terminal and the output terminal without passing through the regulator on or off, according to the bypass selection signal.

2. The dual-mode switching regulator of claim 1, wherein the comparison unit comprises an operational amplifier having a non-inverting input terminal receiving the input voltage, an inverting input terminal receiving the reference voltage, and an output terminal outputting the comparison result signal obtained by comparing the input voltage with the reference voltage.

3. The dual-mode switching regulator of claim. 2, wherein, when the input voltage is lower than the reference voltage, the operational amplifier outputs a comparison result signal having a low level, and when the input voltage is equal to or higher than the reference voltage, the operational amplifier outputs a comparison result signal having a high level.

4. The dual-mode switching regulator of claim 1, wherein the switching signal generation unit generates a regulator selection signal and a bypass selection signal, each including a first switching signal corresponding to a level of the comparison result signal and a second switching signal obtained by inverting the first switching signal.

5. The dual-mode switching regulator of claim 4, wherein the switching signal generation unit includes an inverter inverting the comparison result signal,
the first switching signal has a level corresponding to the level of the comparison result signal, and
the second switching signal is obtained by inverting the comparison result signal via the inverter.

6. The dual-mode switching regulator of claim 5, wherein the regulator path selection unit includes:
a first switching device connected between the input terminal and the regulator, and switched off when the input voltage is lower than the reference voltage and switched on when the input voltage is equal to or higher than the reference voltage, according to the regulator selection signal; and
a second switching device connected between the regulator and the output terminal and switched off when the input voltage is lower than the reference voltage and switched on when the input voltage is equal to or higher than the reference voltage, according to the regulator selection signal.

7. The dual-mode switching regulator of claim 6, wherein the first switching device is configured as a first transmission gate, and
the first transmission gate includes:
a first NMOS transistor having a drain connected to the input terminal, a source connected to the regulator, and a gate receiving the first switching signal; and
a first PMOS transistor having a drain connected to the input terminal, a source connected to the regulator, and a gate receiving the second switching signal.

8. The dual-mode switching regulator of claim 7, wherein the second switching device is configured as a second transmission gate, and
the second transmission gate includes:
a second NMOS transistor having a drain connected to the regulator, a source connected to the output terminal, and a gate receiving the first switching signal; and
a second PMOS transistor having a drain connected to the regulator, a source connected to the output terminal, and a gate receiving the second switching signal.

9. The dual-mode switching regulator of claim 5, wherein the bypass path selection unit includes a third switching device formed on the bypass path between the input terminal and the output terminal, and switched on when the input voltage is lower than the reference voltage and switched off when the input voltage is equal to or higher than the reference voltage, according to the bypass selection signal.

10. The dual-mode switching regulator of claim 9, wherein the third switching device is configured as a third transmission gate, and
the third transmission gate includes:
a third NMOS transistor having a drain connected to the input terminal, a source connected to the output terminal, and a gate receiving the second switching signal; and
a third PMOS transistor having a drain connected to the input terminal, a source connected to the output terminal, and a gate receiving the first switching signal.

11. A dual-mode switching regulator comprising:
a comparison unit comparing an input voltage input through an input terminal with a pre-set reference voltage and outputting a comparison result signal;
a switching signal generation unit generating a regulator selection signal for controlling a previously connected regulator path and a bypass selection signal for controlling a previously connected bypass path according to the comparison result signal;
a regulator included in the regulator path and converting the input voltage to a pre-set voltage;
a regulator path selection unit switching the regulator path including the regulator between the input terminal and an output terminal on or off, according to the regulator selection signal; and
a bypass path selection unit switching the bypass path connecting the input terminal and the output terminal without passing through the regulator on or off, according to the bypass selection signal,
wherein the regulator path selection unit includes:
a first switching device connected between the input terminal and the regulator, and switched off when the input voltage is lower than the reference voltage and switched on when the input voltage is equal to or higher than the reference voltage, according to the regulator selection signal; and
a second switching device connected between the regulator and the output terminal and switched off when the input voltage is lower than the reference voltage and switched on when the input voltage is equal to or higher than the reference voltage, according to the regulator selection signal, and
the bypass path selection unit includes a third switching device formed on the bypass path between the input terminal and the output terminal, and switched on when the input voltage is lower than the reference voltage and switched off when the input voltage is equal to or higher than the reference voltage, according to the bypass selection signal.

12. The dual-mode switching regulator of claim 11, wherein the comparison unit comprises an operational amplifier including a non-inverting input terminal receiving the input voltage, an inverting input terminal receiving the reference voltage, and an output terminal outputting the comparison result signal obtained by comparing the input voltage with the reference voltage.

13. The dual-mode switching regulator of claim 12, wherein when the input voltage is lower than the reference voltage, the operational amplifier outputs a comparison result signal having a low level, and when the input voltage is equal to or higher than the reference voltage, the operational amplifier outputs a comparison result signal having a high level.

14. The dual-mode switching regulator of claim 11, wherein the switching signal generation unit generates a regulator selection signal and a bypass selection signal, each including a first switching signal corresponding to a level of the comparison result signal and a second switching signal obtained by inverting the first switching signal.

15. The dual-mode switching regulator of claim 14, wherein the switching signal generation unit includes an inverter inverting the comparison result signal,
the first switching signal has a level corresponding to the level of the comparison result signal, and
the second switching signal is obtained by inverting the comparison result signal via the inverter.

16. The dual-mode switching regulator of claim 15, wherein the first switching device is configured as a first transmission gate, and
the first transmission gate includes:
a first NMOS transistor having a drain connected to the input terminal, a source connected to the regulator, and agate receiving the first switching signal; and
a first PMOS transistor having a drain connected to the input terminal, a source connected to the regulator, and agate receiving the second switching signal.

17. The dual-mode switching regulator of claim 16, wherein the second switching device is configured as a second transmission gate, and
the second transmission gate includes:
a second NMOS transistor having a drain connected to the regulator, a source connected to the output terminal, and a gate receiving the first switching signal; and
a second PMOS transistor having a drain connected to the regulator, a source connected to the output terminal, and a gate receiving the second switching signal.

18. The dual-mode switching regulator of claim 17, wherein the bypass path selection unit includes a third switching device formed on the bypass path between the input terminal and the output terminal, and switched on when the input voltage is lower than the reference voltage and switched off when the input voltage is equal to or higher than the reference voltage, according to the bypass selection signal.

19. The dual-mode switching regulator of claim 18, wherein the third switching device is configured as a third transmission gate, and
the third transmission gate includes:
a third NMOS transistor having a drain connected to the input terminal, a source connected to the output terminal, and a gate receiving the second switching signal; and
a third PMOS transistor having a drain connected to the input terminal, a source connected to the output terminal, and a gate receiving the first switching signal.
